(19) United States
(12) Patent Application Publication
(10) Pub. No.: US 2022/0383308 A1
(43) Pub. Date: Dec. 1, 2022

(54) PAYMENT CARD SECURITY

(71) Applicant: Focus Universal Inc., Ontario (CA)

(72) Inventor: Desheng Wang, Diamond Bar, CA (US)

(21) Appl. No.: 17/748,941

(22) Filed: May 19, 2022

Related U.S. Application Data
(60) Provisional application No. 63/190,607, filed on May 19, 2021.

(51) Int. Cl. G06Q 20/38; G06Q 20/40

(52) U.S. Cl. CPC G06Q 20/38215; G06Q 20/389; G06Q 20/4014

(57) ABSTRACT

Disclosed is a system and method for more secure card transactions. The security is generated by the use of a dynamic transaction number which is valid for only a single predetermined time interval. The transaction number is generated through a two step process. In a first step, time is used as an input to a transaction number function. The transaction number function outputs a plurality of digits. The second step uses the plurality digits for input and uses a ruleset to strip at least one digit to determine the transaction number valid for the predetermined time interval.

### CROSS-REFERENCE TO RELATED APPLICATIONS

The present application claims the benefit of priority to U.S. Provisional Patent Application No. 63/190,607, filed May 19, 2021, the disclosure of which is hereby incorporated by reference in its entirety. Any and all applications for which a foreign or domestic priority claim is identified in the Application Data Sheet as filed with the present application are hereby incorporated by reference under 37 CFR 1.57.

### FIELD

The present invention relates to payment card security.

### BACKGROUND

Credit card fraud is a growing area of concern. As more sophisticated security for account numbers and transactions is developed, criminals develop ever more sophisticated counters to enable the criminals to gain access to account numbers, personal identification numbers (PIN) and card verification values (CVV). Although the existence of these numbers makes it more difficult for someone to obtain all of the information associated with an account over the internet, a criminal stealing a physical card or with a skimmer and a key logger, will get both these numbers, and on most systems, will be able to conduct fraudulent transactions.

Such information is most vulnerable while being transmitted or input in to a payment processing system. If a state-of-the-art static card number is captured at input or in transmission, it can be used in the future. Many transmissions might also include the CVV number as well. Thus, when a criminal obtains the input or the transmission, the criminal captures all the information required for a transaction, and knows, that at least for some time, typically at least a number of hours, that information will remain static and can be used.

However a criminal might gain access to the information, the state-of-the-art remedy for a card number or account being compromised is to change a static account number and CVV in to a dynamic one, that is, change the number and issue a new card. Account numbers and associated CVVs are static, that is, they don't change, at least for the period in which the card is valid. The account number or CVV or both may be changed when a card renews, or when fraudulent activity is discovered, but remains static for a vast majority of the time. This means that a criminal illegally using the card to make purchases is almost always able to make one or more fraudulent transactions before it is discovered that the information has been compromised.

For the foregoing reasons, there is a need for a card security system which can defeat the fraudulent obtaining of card or account information or provide a deterrent for criminals looking to obtain and use such information.

### SUMMARY

In some embodiments, a system for greater security of a payment card number can include a virtual card application configured to run on a smart device. The smart device can include a first processor electrically connected to a first memory having stored thereon the payment card application. The first processor can be configured to execute the virtual card application. The virtual card application can include a transaction number algorithm that includes one or more functions. The transaction number algorithm can include a transaction number function that uses time as a variable to generate a first transaction number function output. The virtual card application can further include a ruleset that uses the first transaction number function output as an input and strips at least one randomly determined digit from the first transaction number function output to determine a first transaction number. The system can further include an issuer server electronically connected to the smart device. The issuer server can receive the first transaction number from the payment card. The issuer server can include a second processor that is electrically connected to a second memory that has a copy of the transaction number algorithm thereon. The second processor can be configured to execute the copy of the transaction number algorithm that includes a copy of the transaction number function using time as an input. The transaction number algorithm can output a second transaction number function output. The issuer server can include a copy of the ruleset that inputs the second transaction number function output and strips predetermined digits from the second transaction number function output to determine a second transaction number to check against the first transaction number from the payment card.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a schematic view of a front of a payment card;

FIG. 2 shows a schematic view of a rear of a payment card;

FIG. 3 shows a schematic view of the system;

FIG. 4 shows a flowchart of a method of determining a transaction number.

### DETAILED DESCRIPTION

The detailed description set forth below in connection with the appended drawings is intended as a description of the presently preferred embodiment of a system and method to provide security for payment cards, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

Currently, when the security of a payment card, which may be debit or credit, is breached, the action taken by the issuer to remedy the breach is to turn the card number dynamic. That is, the issuer provides a new card with a new card number. Disclosed herein is a system and method which takes this curative measure and instead uses the same measure proactively to provide security that prevents fraud, rather than helping a cardholder and an issuer recover from the fraud.

The heart of the security of the disclosed payment card system and method consists of a transaction number algorithm of two parts. The first part is established during account creation. During account creation, an issuer encodes a transaction number function rather than associating a static card or account number with the account. In some embodiments, the transaction number function has a single variable. That variable is time. Thus, the transaction number generated by either an issued payment card or during validation at the issuer is dynamic as a function of time. In some embodiments, the function may be a linear formula, such as a(t)+b=x, with the variable “t” being time. Alternatively, it may be any function the issuer wishes to use, and the function may change the function from account to account. Preferably, the function is a highly oscillating or a discrete function. A discrete function may include a table stored in memory as described in further detail below. Still further alternatively, the transaction number function may include any number of variables, given only that the payment card and issuer server can both independently track the variable and either synchronize to a standard or, independently of a transaction request, to one another. The second part of the security of the disclosed payment card system is that certain predetermined digits of the result from the function are stripped before the transaction number is output. By way of example and not limitation, it may be the first three digits of the output result of the transaction number function which are stripped from the output. Alternatively, it is contemplated that non-consecutive digits may be stripped from the output, and that more than three, or fewer than three, digits may be stripped from the output. Further, the number or pattern of digits being stripped may change from account to account, and correspondingly, from card to card. The number or pattern of digits being stripped may change from transaction to transaction for even the same card and account.

In one embodiment, to initiate a transaction, the cardholder swipes the payment card to provide the transaction number and identifying information to the merchant. The transaction number is determined at specified time intervals by the payment card. For example, the payment card may determine a new transaction number every minute. Alternatively, the transaction number may be determined at intervals less than a minute or more than a minute. The transaction number is determined using time as an input to the function, and then the transaction number algorithm continues, taking the output of the function and stripping certain digits of that output to determine the output transaction number. This process is discussed in detail below.

The physical card would still need to be safeguarded because, at least in some embodiments, if a criminal obtained control of the card, the criminal would have access to both the function, and the means to determine which digits of the function output are to be stripped.

The transaction number is sent from the merchant to a processor, along with identifying information. The processor presents the transaction number and identifying information to the issuer. The issuer first uses the identifying information to determine which account should be used to validate the transaction number presented by the processor.

The issuer stores the entire transaction number algorithm. That, is, the issuer stores both the same transaction number function and the instructions on which digits of the function output are to be stripped keyed to the account. Using the time as provided by radio wave as an input, the issuer determines the output of the transaction number function, and then uses the instructions on which digits to strip to determine the output transaction number. The issuer checks the output transaction number against the one provided by the issuer. If there is a match, the transaction number is validated, and the issuer approves the transaction.

The information stored at the issuer would need to be carefully safeguarded, but it is already common industry practice to provide security for account information. Again, the disclosed system and method is directed at increasing the security of the, in the state-of-the-art, vulnerable input and transmitted information. The disclosed system and method do so through the transaction number algorithm, which replaces the typical static card number. The transaction number algorithm provides a more secure transaction number, at least in part because the transaction number is changing with every time interval. Even if the card transaction number is intercepted, the transaction number is not be static, and therefore cannot be used outside of the time interval or again within the same time interval. Nor can the transaction number be predicted, even if the function is discovered, because certain digits of the function output are stripped from it, and the transaction number cannot be predicted without both pieces of information.

The digits which are to be stripped may be determined in one of several different ways. In a first embodiment, the digits to be stripped may be the same for all accounts maintained by an issuer. For example, the second step of the transaction number algorithm may be instructions that the first, second, and fourth digits are always to be stripped. While this option provides additional security, it provides the least additional security of the different embodiments disclosed herein.

In a second embodiment, the issuer may set instructions as to which digits are to be stripped on an account by account basis. That is, the function output digits which are being stripped are different for each account maintained by the issuer, or, at least, which digits being stripped are rarely duplicated.

In a third embodiment, the digits to be stripped may change in either of the above circumstances. That is, the digits to be stripped may also be determined by a second function for which time is the variable. By way of example and not limitation, the first three digits of the result of the function may be used. If one of the digits is a repeat of a previous digit, that digit may be skipped, until all three are unique. Alternatively, if the digit is a one, the next digit may be combined to get a digit between 10 and 16. If the next digit in making the two-digit combination is greater than 6, it may be passed over until a digit less than 6 is found.

In some embodiments, the issuer may provide the hardware which duplicates the processor network. When the issuer provides this hardware, the validation may take place, in whole or in part on this hardware, rather than entirely on the issuer server 26. For example, the time may be obtained by the hardware performing the actions of the processor network. This may lead to fewer “false positives” as discussed below, because the time is being acquired earlier in the process.

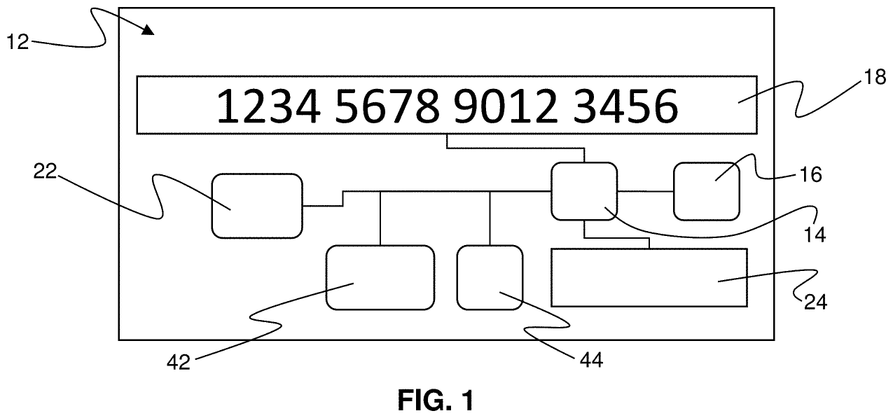

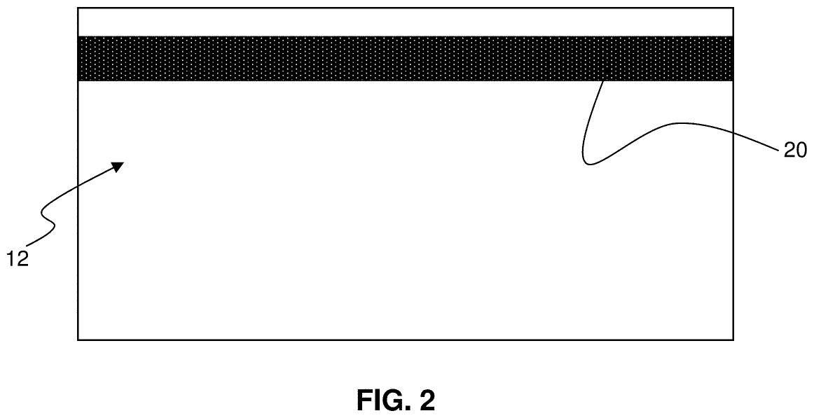

As shown in FIGS. 1 and 2, a payment card 12 includes hardware to generate a transaction number and to transmit required information in a transaction request. The payment card 12 includes a processor 14 and a memory 16, the memory 16 including the transaction number algorithm used to create the transaction number and instructions to the transaction number to be output to one or more output components. The output components may include displays 18 and transmission components. The transmission components may include a magnetic strip emulator 20, or a chip 22, or both. The processor 14 and the memory 16 may be electrically connected by wiring, traces on a printed circuit board, or other means known in the art.

The payment card 12 may further include a wireless transceiver 24 to receive a signal which carries information detailing the correct time. The wireless transceiver 24 may be electrically connected to the processor 14 by wiring, traces on a printed circuit board, or other means known in the art. As used herein, a wireless transceiver 24 may include a radio receiver, a WiFi® transceiver or receiver, a Bluetooth® transceiver or receiver, or a transceiver or receiver for any of a number of other well know wireless protocols. When the wireless transceiver is a radio receiver, the radio signal or signals received may be, for example in the United States, a broadcast signal originating from a station broadcasting near Fort Collins, Colo. The Fort Collins station includes an antenna array which broadcasts at 60 kHz, 2.5 MHz, 5 MHz, 10 MHz, 15 MHz, 20 MHz, and 25 MHz, at powers varying from 1 kW to 70 kW. The wireless transceiver 24 may receive one or more of these signals, demodulate the signal to obtain the time data, and pass the time to the processor 14. The processor 14 may use the time to determine the output of the transaction number function as is described further below.

The payment card 12 may also include a display 18 for displaying an output of the transaction number. The display 18 may use any of a number of display technologies, including e-Ink displays, liquid crystal displays (LCD), and other technologies known in the art. The display 18 may allow the cardholder to enter the current transaction number in a payment field in a window for an online transaction. The display 18 may be electrically connected to the processor 14 by wiring, traces on a printed circuit board, or other means known in the art.

As one of a plurality of output components, the magnetic strip emulator 20 may provide the transaction number to a magnetic strip reader. The magnetic strip emulator 20 may be like magnetic strip emulator 20 disclosed in the U.S. Pat. No. 7,246,752, the contents of which are incorporated herein by reference. The magnetic strip emulator 20 may be electrically connected to the processor 14 by wiring, traces on a printed circuit board, or other means known in the art.

Another output component may be the embedded chip 22. The chip 22 may be adapted to interact with a point-of-sale (POS) system to enable the transaction. This interaction is similar to that of a typical magnetic strip, but may be more secure, as the chip 22 may include additional identification information or other authentication or identification information. The embedded chip 22 may use the Europay Mastercard Visa (EMV) standard of 1998. The chip 22 may be electrically connected to the processor 14 by wiring, traces on a printed circuit board, or other means known in the art. The operation of the payment card 12 is discussed further below.

Additionally or alternatively, the payment card may be embodied in a virtual card. The virtual card may be embodied in a software application on a smart device. The smart device may be a smart phone, a tablet, a watch, or any mobile device capable of contactless payments using, for example, near field communications (NFC), radio frequency identification (RFID) or other methods to transmit or display a payment card number or code. The smart device may include a memory on which the application is stored and a processor which executes the computer code comprising the application. The smart device may further include hardware equivalent in function to that required to make a stand-alone hardware payment card function. In many cases, the hardware included on the smart device may be more powerful than the hardware performing the same function on the hardware payment card. This is almost certainly true for the previously mentioned processor and memory. The more powerful processor may be able to use more complex functions, as discussed below. Moreover, the memory may be able to store larger and more complex algorithms. As additional examples, the smart device may include a larger display, a more powerful and rechargeable battery, and more powerful time keeping hardware. Because the battery is rechargeable, the virtual card may function indefinitely, and is not be limited by the battery life of a non-rechargeable battery. Non-rechargeable batteries make the hardware payment card cost effective, and are a better fit for those embodiments. The time keeping hardware may include the same or different components to the hardware payment card described herein. For example, both may include a crystal oscillator. Regardless of the specific hardware arrangement, almost all smart devices have access to external timekeeping through either WiFi® or Cellular technology, and often both. These external sources can be used to synchronize any native time keeping device. However, the time keeping device native to the smart device is often accurate enough to function until the smart device receives either a cellular or WiFi® signal. Given that the virtual payment card can use all of the native hardware of a smart device, the virtual card may be deployed at a much lower cost than the hardware version of the payment card.

The application may include the same transaction number algorithm stored on embodiments of the hardware payment card. Moreover, the transaction number algorithm in the application embodying the virtual payment card may include two steps similar to the transaction number algorithm in embodiments of the hardware payment card. For the second step of the transaction number algorithm, manual digit stripping is preferred, as manual digit stripping by the user provides more security than other forms of digit stripping. Manual digit stripping is more secure because the instructions as to which digits are to be stripped are not stored on the smart device, and therefore cannot be stolen if the smart device is hacked. The application may have a first module that includes the transaction number algorithm, and may have a second module which presents the transaction number to the contactless payment terminal.

The virtual payment card transaction number module may include the transaction number algorithm. Similar to embodiments of the hardware payment card, the transaction number algorithm may include a transaction number function which outputs a set of digits. The transaction number algorithm may further include a digit stripping ruleset which receives the output set of digits from the transaction number function, strips predetermined digits from the output of the transaction number function, and outputs a transaction number. The transaction number function may be any function, including all of the functions discussed above and below. However, as will be described in further detail below, the transaction number function is preferably a highly oscillating function or a table stored within the algorithm. The table may be a discrete function in which sets of digits are assigned to time/date/year intervals as is described in detail below. The entries in the table may be highly randomized, with the entries not formed using any function or pattern.

The second step in the transaction number algorithm is digit stripping. This step is preformed according to the digit stripping ruleset. In a preferred embodiment, the output of the transaction number function may be displayed on the display of the smart device. The user may perform the digit stripping manually based on a ruleset that the user has memorized, rather than a ruleset that is stored on the smart device. The virtual card application may provide one or more control surfaces on the display of the smart device which the user may manipulate. Similar to the hardware payment card, the control surfaces may include a control surface which moves a cursor in either direction to select digits among the transaction number function output, another control surface which allows a user to delete a selected digit, and a control surface to indicate that the user has completed stripping digits from the transaction number function output. Each control surface may be separate, or the directional control may be combined in to a single control surface with two separate regions. Each region of the control surface may allow the user to move the cursor in opposite directions. The virtual card may prefer to use manual digit stripping in the second step of the algorithm as being more secure than other embodiments. Alternatively, the virtual card may use any embodiment of digit stripping discussed above or below.

The virtual card application may further include a contactless payment module. Using contactless payment methods known in the art, the contactless payment module may receive the transaction number as an output from the transaction number algorithm, and the contactless payment module may transmit the transaction number through the contactless payment terminal to a payment network. For example, after a user uses the control surface to indicate the user has completed digit stripping in the embodiment discussed above, the contactless payment module may inform the user, for example, by displaying a message on the screen, that the virtual card application is ready to process a payment. The user may then process the payment using the contactless payment system. The smart device, using NFC, which is based on radio frequency identification (RFID) technology, will send the transaction number to the contactless payment terminal. From this point, the transaction proceeds across the payment network in the same manner as that processed for a hardware payment card, as is described in detail below.

Alternatively, or in addition, the contactless payment module may provide a scannable image on the screen encoding the transaction number. For example, the contactless payment module may display a card number, or a code, such as a bar or quick response (QR) code, on the display. Scanning the code with a scanning tool may provide the transaction number to the computing device connected to the scanning tool. The scanner may be a handheld or stationary scanner. For example, at a typical checkout at a retail store, the registers have both a handheld scanner and a stationary scanner for scanning bar codes. When the retail location does not have a contactless payment terminal, it may instead use gift cards with a barcode encoded with the amount. The contactless payment module may include instructions for encoding the transaction number in a bar code for scanning at such locations. The contactless payment module may provide a menu to the user on the display of the smart device, the menu allowing the user to choose one of a plurality of virtual card formats for use in different payment scenarios. The contactless payment module may then encode the transaction number according to the choice of the user.

Similar to other virtual cards or pay services such as Apple® Pay, there is very little to no security concern regarding the transmission of the transaction number to the contactless payment terminal, or at a terminal which does code scanning. This is because the virtual card transaction number changes at predetermined intervals just as the hardware payment card does. Even if someone were to obtain the transaction number for one-time interval, the transaction number would not be usable in the next time interval. With relatively short time intervals, it would be nearly impossible for one to obtain, and then use, the transaction number within a single time interval.

In addition to physical payments at a retail location, the virtual payment card may also be used for online payments. Because the virtual payment card may use typical payment card number formats, the payment card numbers may be sent using any number of payment services which use card numbers, for example, PayPal® among many others. Further, the card may be tied to accounts for processing with non-card payments which use a regular banking account, for example, a checking or savings account as a pass through.

The virtual card, coupled with the hardware of a smart device, may offer additional advantages. First, because the virtual card is a pure software addition to the smart device, updates are much easier. Moreover, additional functionality may be added the same way as updates. For example, in the future the virtual card may make use of artificial intelligence (AI) to update or change aspects of the algorithm on the fly. This technology may be added in a simple update to the smart device. Such an update would be much more difficult with the hardware payment card. In addition, the virtual payment card may include an interface with a cloud storage service. This may enable additional record keeping functions which would be nearly impossible with the hardware payment card. Similarly, the virtual payment card may interface with one or more e-mail applications present on the smart device to provide notifications to a user, and even such notifications via e-mail may be used to enhance record keeping.

Whether in virtual or physical form, the card may include digits which are static as well as digits which are dynamic. The static digits may come before the dynamic digits, after the dynamic digits, between dynamic digits in one or more places in the transaction number. The static digits may be as few as one digit or as many as 20 digits. In some embodiments, the static digits may be more than 20 digits, particularly with virtual cards which lack the space limitations of physical cards.

The static digits may be indicative of an identification. The identification may be indicative of the card holder, the card issuer, or both. Alternatively, or in addition, the identification information may be indicative of an organization to which the card holder belongs. Whether virtual or physical, the static digits may be displayed in a manner no different than the dynamic digits. In fact, in some embodiments, the static digits may be inserted as part of the transaction number function. Essentially, the static digits may be inserted in the appropriate location in the transaction number output in a set just before the transaction number output is sent to the digit stripping ruleset. In other embodiments, the static digits may be inserted after the digit striping is complete. In these embodiments, the static digits are always present in the output of the transaction number algorithm.

In some embodiments of both the physical and virtual cards, the transaction number algorithm may be used to determine not just the payment card number, but also a credit card verification (CCV) number as well. In still other embodiments, the transaction number algorithm may be used to determine the CCV alone. In these embodiments, the CCV may be three digits or more than three digits. For example, the CCV may be 16 digits, and the transaction number may also be 16 digits. The increased number of digits in the CCV, and well as the method for obtaining the CCV may increase the security of any individual transaction, and the security of the account as a whole.

In embodiments where the transaction number algorithm produces both the transaction number and the CCV, both numbers may be produced as a single string by the transaction number algorithm. That is, a string of digits may be produced by the algorithm as described above and below, and then, as a final step in the algorithm, the resulting output of the digit stripping ruleset may then be separated in to two parts. The first part may be the transaction number, representing the card number for use in the transaction. The second part may be the CCV number, representing the CCV to secure the transaction. In embodiments where a physical card is present, the first part may be displayed on a first screen and the second part on a second screen. Alternatively, the first part and second part may be displayed in two distinct locations on the same screen. In virtual card embodiments, the first part and second part may not be displayed at all. Rather, the first part and second part may be transmitted in separate data fields without being physically displayed. Alternatively, the transaction number and the CCV may have differing algorithms based on the number of digits for each, and these algorithms may run simultaneously during each time interval.

The fact that the first part and second part are not displayed may add security to the transaction and account. For each transaction, the first part and the second part may be stored in memory for later reference by a user. The memory may be cloud storage rather than local storage on which the virtual card application is running. This allows for space savings on the memory of the smart device, while still allowing accessibility to the data.

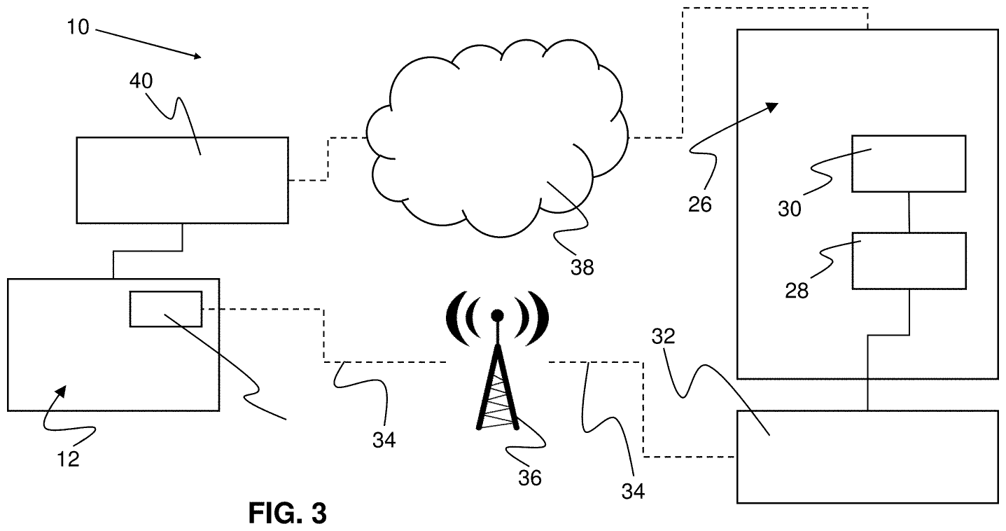

In reference to FIG. 3, the payment card 12 forms part of a system 10. A typical transaction will involve a system with at least a cardholder, a merchant, an acquirer, an issuer and a processor. The cardholder is typically an individual, but may be an organization, such as a business or a non-profit entity, and physically holds the card associated with the account opened with the issuer. The merchant is the entity from which the cardholder wishes to purchase either goods or services. The acquirer is the financial institution providing the account to which the funds are being paid on behalf of the merchant. The issuer is the financial institution providing the account from which the funds are being paid on behalf of the card holder. The processor may provide a payment processing network or another system which routes the funds from and to the different accounts upon receiving approval from the issuer. However, only the card holder, merchant, issuer and processor are involved in the approval or validation sub-process. The validation sub-process may only include the card holder, merchant and issuer if the issuer has a network which performs processing functions.

The payment card system 10 may further include a server 26 controlled by the issuer. The server 26 may include at least one processor 28 and at least one memory 30. The memory 30 may have records stored thereon. The records may include account information. The account information may include identification information. The identification information may include personal information such as a name and a PIN, or address, or other information used to associate a transaction request with an account maintained by the issuer on behalf of the cardholder. The account information may further include the transaction number algorithm, specifically, the transaction number function used to determine the transaction number, and the instructions used to determine which digits are to be stripped from the output of the transaction number function.

The memory 30 may further include instructions for communicating with other devices, for example, when validating transactions and when sending funds after a transaction has been validated and approved. The operation of the instructions is described further below.

The server 26 may be electrically connected to a radio receiver 32 through wiring, traces on printed circuit boards, or other means known in the art. The radio receiver 32 may receive longwave radio signals 34 which include information regarding the current time. One common style of radio receiver 32 uses time signals transmitted by dedicated terrestrial longwave radio transmitters, which emit a time code that can be demodulated and further processed by the radio receiver 32, including being displayed or sent as data to other components in a system. The radio receiver 32 may also contain an oscillator, for example, a crystal oscillator, to maintain timekeeping if the radio signal is unavailable. The quality of the crystal oscillator may be chosen is balance cost and performance. For example, the crystal oscillator may include imperfections on the order of 50 PPM. Such an oscillator may have an inaccuracy of 4 seconds in 24 hours. Thus, the payment card 12 may need to synchronize with an external standard to prevent the internal timing device, such as the crystal oscillator, from drifting too far from a time standard. When the payment card 12 is in contact with the external time standard, for example, either the radio signal or a WiFi® time code, the payment card 12 may synchronize with every time interval. However, it is not required that the payment card 12 maintain contact with a synchronization standard, only that the payment card 12 synchronize within the required synchronization interval. The synchronization interval is the time interval in which the payment card needs to synchronize the time with an external standard to avoid drift that would cause inaccurate transaction numbers to be delivered to the server 26, as discussed in further detail below. Thus, depending on connectivity, the internal time keeping device, for example, the crystal oscillator, may be the primary time keeping device. When there is connectivity readily available, the radio signal or time code from the WiFi® connection may be the primary time keeping device.

Alternatively, the payment card 12 and the server 26 may both include wireless or wired connections. The wireless or wired connections may connect to either a local are network or a wide area network, or both. The payment card 12 and the server 26 may both obtain time signals through the network and use the time signals obtained from the network to synchronize the time. The payment card 12 and the server 26 may synchronize the time at predetermined intervals. For example, the payment card 12 and the server 26 may synchronize once in 24 hours, and then may, keep time through on board means, for example, through the oscillator discussed above. Alternatively, the payment card 12 and the server 26 may synchronize more often than once in 24 hours, or less often than once in 24 hours, in part depending on the accuracy of the on-board time keeping device and the time interval chosen for the payment card. For example, if the time interval is one second, then the payment card 12 may need to synchronize with an external time standard, either through radio, WiFi® or other means every hour. However, if the time interval is longer, for example five minutes, the payment card 12 may only need to synchronize every week.

The radio signals 34 may be sent from a central location and modulated to include information as to the current time. The radio signals may be referenced to a very accurate time keeping device, for example, an atomic clock. In the United States, the radio signal used may be that sent from a station 36 broadcasting near Fort Collins, Colo. for example. The Fort Collins station includes an antenna array which broadcasts at 60 kHz, 2.5 MHz, 5 MHz, 10 MHz, 15 MHz, 20 MHz, and 25 MHz, at powers varying from 1 kW to 70 kW. The radio receiver 32 may receive one or more of these signals to determine the time. The radio transmissions contain a time code that may be demodulated and then used as data in the transaction number algorithm. With the time data input, the processor may determine an output from the transaction number function. Time may also be used as an input to a second function which determines which digits are to be stripped from the output of the transaction number function,

The server 26 at the issuer may be further electronically connected to a processor network 38. The electrical communication allows the server to send messages on the processor network 38 to other devices connected to the processor network 38. The processor network 38 may carry transaction requests from POS devices 40 at merchants and route the transaction requests to the corresponding issuers. The transaction requests may include identification information for the cardholder making the transaction request. Alternatively, the issuer may have a direct connection to the merchant, and not use a processor. Such circumstances are rare, and when such circumstances do occur, the issuer must essentially duplicate the hardware of the processor network 38. The transaction request may further include the transaction number as provided to the processor by the payment card 12. In order to validate the transaction request, the server 26 may use the processor 28 and instructions stored on the memory 30 to compare transaction numbers, as is discussed further below with the operation of the system 10. The server 26 may use the processor network 38 to send approvals or denials of the transaction to the merchant. The server 26 may also use the processor network 38 to perform the transaction, sending the amount of money in the transaction request to the acquirer on behalf of the merchant.

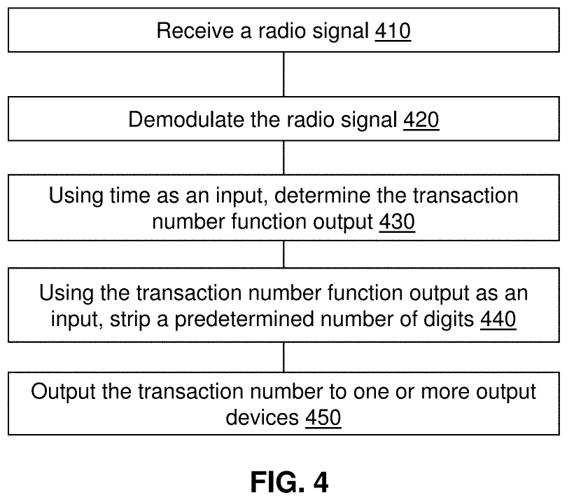

With reference to FIGS. 1-4, in operation, a future cardholder may contact the issuer in order to establish an account with the issuer. The issuer may agree to open and maintain an account on behalf of the future cardholder, who, at that point, transitions to simply a cardholder. As part of the account creation process, the cardholder may provide identification information to the issuer. The identification information may be used to set up the account, and may be used in conjunction with one or more transaction requests made in the future. The identification information, when used in conjunction with a transaction request, may allow the issuer to identify the account corresponding to the validation request. This identification information, or at least a portion thereof, may be placed on the payment card 12 for transmission as part of a transaction request.

Contemporaneously, the issuer may assign a transaction number algorithm to the account, and save the transaction number algorithm and the identification information on the memory 30 of the server 26. The transaction number algorithm may have two steps. The first step includes determining an output form the transaction number function. The transaction number function may be used in determining the transaction number used in the transaction request, as well as generating a transaction number used to validate the transaction request. The transaction number function may take any of several forms. By way of example, and not limitation, the transaction number function may be a linear equation of the form a(t)+b=output, where “t” is time, “a” is a predetermined coefficient, and “b” is a constant, typically a non-zero integer. In order to make the time function properly in the transaction number function, the time may be converted to a Julian-style expression. For example, the minute starting at midnight to 59 seconds after midnight is the first minute of the day, and thus may be expressed as minute one, and a “1” used as the time in the transaction number function. The following minute may be expressed as minute two, and a “2” used in the transaction number function, and so on until minute 1440. Alternatively, the first minute may be 1440, and the minutes would count down from 1440 to 1. As a third alternative, a random number generator may be used to determine a starting point between 1 and 1440. The time will then increment up to 1440 and then cycle to 1, and back up to one less than the starting point. To this, the date may be added so that no input repeats. The date, month, and year may all be added to the minute. For example, if it was minute 853 of Jan. 5, 2020, the full number may be 853152020. The first three digits representing the minute, the next one or two digits representing the month, with two digits being used specifically for October, November, and December, the next one or two digits being used for the day, with two digits being used for the 10^{th} day of the month and beyond, and the last four digits representing the year.

Alternatively, the transaction number function may use a sine, cosine, or tangent function. The sine, cosine, or tangent function may take the place of the “a” in the line function. Thus, the complete transaction number function may be, for example, sin(t)+b=output. Again, “t” is the time, which may be determined in any of the ways discussed above. The letter “b” represents a constant, typically a non-zero integer.

The transaction number function may be any function the issuer wishes to use, and is not limited to these examples. Some functions may return more randomized results than others, and may be more desirable for that reason. For example, the transaction number function may be a highly oscillating function of the form:

$$\text{?} sin ( \text{?} ) \\ or \\ \text{?} cos ( \text{?} ) \\ or \\ ( b ) {x}^{2} sin ( \text{?} ) \\ or \\ ( x - 1 ) cos ( \text{?} )$$

$$\text{?} \text{indicates text missing or illegible when filed}$$

The issuer may vary the form of the transaction number function from account to account. This provides improved security in that if one account is compromised, the form of the transaction number function cannot be determined for the other accounts. The transaction number function may also be a discrete function. For example, the function may be t\hat{ }2+b, where t is time. As discussed above time may be in discrete intervals, for example one minute intervals, meaning for the function t=(1, 2, 3, . . . 1440) for each day.

Alternatively, the transaction number function may be a table stored in memory. For example, if the time interval is one minute, the table may store a predetermined set of digits. Each set of digits may be of a predetermined length. That is, each set of digits may be 20 digits, or 32 digits, or 36 digits in length. Alternatively, the number of digits may be any number of digits from 2 to hundreds of thousands. The exact number of digits chosen may depend on a number of factors, including the requirements of the system which will pass the transaction number, and the security level desired for the transaction number. In the table, a random number generator may be used to determine a set of digits for each entry. Thus, the entries in the table do not follow any mathematical function or pattern. If the predetermined time interval is one minute, the set of digits may be assigned to minute number 1 in the table. A second set of digits may be determined by the random number generator and assigned to minute number 2 in the table. A third set of digits may be determined by the random number generator and assigned to minute number 3 in the table. This process may continue up to minute 1440 in the table. It is also contemplated that time intervals other than a minute may be used. For example, seconds may be used. In an embodiment where one second is used at the time interval a set of digits may be generated corresponding to every second of the day, from one to 86,400. Time intervals between one second and one minute and more than one minute are also contemplated.

Regardless of the chosen form of the transaction number function, the transaction number always uses time a variable, and the transaction number is set to change at a predetermined time interval. For example, the time interval may be one minute. This disclosure also contemplates time intervals of more than one minute and less than one minute. The technology of the system is able to provide very accurate time intervals due to the precise nature of the radio broadcast and receiver, but any time interval chosen must take in to account the time required for a transaction request to be sent over the processor network 38, and for the validation to the performed on the issuer server 26. This process, is, of course, not instantaneous, but in most circumstances will take less than a minute. Thus, the time interval must at least be long enough for the transaction request to pass through the processor network and then to be validated with the entire transaction number process still producing the same number. The need for this will become more obvious with further discussion of the process below.

Next, the transaction number algorithm moves to the second step. Using the entirety of the output from the transaction number function, the output is reviewed against a ruleset, which may also be termed a set of instructions. The ruleset requires that certain digits within the output from the transaction number function be stripped. In one embodiment, this rule may take a form consistent across all accounts. That is, the ruleset may require that all accounts must strip predetermined digits of the output from the transaction number function, and use the resulting first or remaining 16 digits as the transaction number. By way of example and not limitation, the ruleset may require that the first three digits must be stripped. After stripping the first three digits, the remaining first 16 digits form the transaction number. This disclosure also contemplates ignoring fewer than three digits, and more than three digits. Moreover, there is no requirement that the digits to be ignored be consecutive. It may also be that the ruleset only provides as much of the output of the transaction number function as needed to determine the transaction number. That is, if the resulting transaction number is to be 16 digits, and four digits are to be stripped, then 20 digits are provided. This ruleset is encoded with the account data on both the server 26 and on the payment card 12 as part of the instructions to determine a transaction number. The transaction number is displayed on the payment card 12 for the predetermined time period.

In another embodiment, the transaction number function outputs a result, which may have the number of digits truncated, and each account includes a ruleset which strips different digits from the output, or, at least, rarely duplicates which digits are stripped. In this embodiment, when the issuer opens the account, a method may be used to determine which digits will be stripped from the output of the transaction number function for that specific account. For example, a random number generator may be used to determine which digits will be ignored. If the random number generator returns any duplicate digits within the result from the random number generator, then the generator may be instructed to run again, until a result with no duplicate digits is returned. For example, if four digits are being ignored, then the random number generator might return a four-digit number, for example, 3273. Because the number three appears twice, such a result instructs the processor 28 to run the random number generator again. The second time, the random number generator returns the number 8235. Because none of the digits repeat, an instruction to ignore the second digit, the third digit, the fifth digit, and the eighth digit of the transaction number function output is encoded with the account on the memory 30, and placing the instruction along with the transaction number function on the payment card 12, and encoding the transaction number algorithm. The ruleset is applied to the output of the transaction number function in the second step of the transaction number algorithm to determine the transaction number. The transaction number is displayed on the payment card 12 for the predetermined time period.

In a third embodiment, the cardholder may actively strip the digits from the transaction number function output in the second step of the transaction number algorithm. Further to this, rather than encoding this as instructions on the memory 16 for the processor 14 on the payment card 12 to execute, a set of controls on an exterior surface of the payment card is provided for the card holder to edit the transaction number function output. The set of controls may include a two part button 42 which allows the cardholder to move through the digits of the transaction number function output in either direction, and a delete button 44. The digits which are edited are static through a plurality of time periods. By way of example, and not limitation, a cardholder chooses 61173 as a digit editing code. In this case, the digit editing code is not a traditional code that is entered when the cardholder is prompted, but is representative of the digits to be stripped from the output of the transaction number function. The payment card has instructions which cause a 20-digit transaction number to be presented. The card holder may use the controls to select the third, sixth, seventh, and eleventh digits, and delete them from the output, resulting in a 16-digit transaction number that may be used for a transaction request.

This third embodiment has the advantage of additional security. Because the ruleset providing instructions as to which digits are to be stripped is not stored on the payment card 12 but memorized by the cardholder, a criminal obtaining the payment card 12 would face an extremely difficult time trying to determine which digits should be stripped from the results of the transaction number function output. Which digits are to be stripped would still be stored in the account information, for example, on the issuer's server 26. However, information stored with the issuer is more secure due to the amount of security employed by the issuer to protect account information. Thus, the overall level of security is increased in this third embodiment.

In a fourth embodiment, the digits to be stripped may change with each time interval. That is, the digits to be stripped may be determined by a second function for which time is the sole variable. If one of the digits is a repeat of a previous digit, that digit may be skipped, until all three are unique. For example, the second function may return a result where the first five digits are 43469. Thus, the result can accommodate stripping three, four, or five digits, depending on the chosen ruleset. The above result would mean that the third, fourth, and fourth digits are to be stripped if just three digits are being stripped, and the third, fourth, fourth, and sixth digits are to be stripped if four digits are being stripped, and third, fourth, fourth, sixth and ninth digits of the transaction number function output are to be stripped if five digits are being stripped. Obviously, the fourth digit is repeated. In this case, the ruleset would deal with the case of three or four digits being stripped by moving from the repeated digit to the next digit and then onward. In the case of a five-digit strip, output would be increased to allow for possible repeat digits. Thus, if five digits are being stripped, at least six, and likely seven or more digits to ensure enough alternative digits are available in the circumstance that there are more than one repeat digits. Thus, if several digits in a row are the same, the ruleset requires that the processer keeps moving through the output until non-repeating digits are found. The ruleset, including the determined digits, is applied to the output from the transaction number function, the application of the ruleset determining the transaction number. The transaction number is displayed on the payment card 12 for the predetermined time period. Because the determination of the transaction number is not instantaneous, the transaction number algorithm may start before the previous time interval is over. In this way, a new transaction number is immediately available at the start of a new time interval.

Alternatively, if the digit to be used as determined in the second or third embodiments is a one, a special case occurs. As one possibility of the ruleset, the one may indicate that the first digit of the transaction number function is to be stripped. However, the transaction number includes 16 digits. The tenth through sixteenth digits would be ignored not matter the output if this was on the only way the “1” was interpreted. Thus, this possibility somewhat limits the security which may be provided by the ignoring of the digits.

However, this disclosure provides an alternate way for interpreting a “1” which occurs in the results of either the random number generator, also called the second function. The “1” digit may be combined with the next digit to get a number between 10 and 16. If the next digit in output forming the two-digit combination is greater than 6, it may be passed over until a digit less than 6 is found. There may be some termination rule to moving to further digits in an attempt to find a non-repeating digit. For example, if three digits in a row are greater than six, the ruleset may require that no further searching of digits is allowed, and the digit is interpreted as a “1,” representing the first digit of a series. This disclosure also contemplates review of fewer than three digits and review of more than three digits for this rule.

Both the transaction function and the rule regarding ignoring predetermined digits may be placed on the payment card 12, with the exception of the embodiment where the cardholder performs the deletion of the digits. At or before the predetermined time interval, the payment card 12 uses the received time to run the transaction number algorithm, determining an output from the transaction number function, and then either uses that output, along with the rule requiring the ignoring of certain digits of that output to determine the transaction number for that time interval, or outputs the first 20 digits of that output for the cardholder to further process using the controls accessible from the exterior surface of the payment card 12. If the transaction number is not used during that time interval, it is discarded. If it is used, it may not be used again during the same time interval. Thus, not additional transaction may be performed until the next time interval.

Further, the instructions may include a rule that requires a user to override a security protocol if transactions occur in three consecutive predetermined time intervals. For example, if the predetermined time interval is one minute, and transactions occur in a first minute, the minute following, and the minute following that one, the issuer may freeze further validation of transaction requests until a user either enters an override code on the card using controls provided on the payment card 12, or logs in to a website provided by the issuer to remove the lockout. This lockout measure provides additional security, as a user is unlikely to have multiple transactions within such a short time interval. Such use of a payment card 12 is far more indicative of fraudulent use than cardholder use. Thus, this measure strikes a balance between an allowance for some irregular cardholder use in exchange for allowing a minimal amount of fraudulent use, and the resulting cost.

In a typical transaction, the cardholder may initiate the process by using the payment card to create a transaction request at a merchant. In the one embodiment above where the cardholder manually deletes the extra digits of the transaction number function, such action would have to be taken prior to initiating a transaction request. In any embodiment, prior to the initiation of a transaction, as seen in FIGS. 1-4, the payment card 12 receives a radio signal in step 410. The payment card 12 demodulates that radio signal to obtain information regarding the current time in step 420. At the next time interval, the payment card 12 executes the transaction number algorithm by using time as an input to the transaction number function, generating the transaction number function output in step 430. Also prior to initiating a transaction, the payment card 12, using the transaction number function output as an input, applies the ruleset to strip a predetermined number of digits from the output to determine a transaction number, as is shown in step 440. In step 450, the transaction number is output to one or more output devices, for example, the display 18 and the card emulator 20.

The cardholder may create the transaction request by using the card at a merchant point-of-sale (POS) system 40. The POS system 40, as part of the transaction request obtains identification information and a transaction number from the payment card 12. The POS system 40 may then transmit the identification information and transaction number to a processor network 38.

Physically, the cardholder may either insert the card to the POS system 40, where the POS system 40 reads the chip embedded in the payment card 12, or the cardholder may swipe the payment card 12 using the magnetic strip emulator 20 to transfer the required information to the POS system 38. When the payment card 12 is inserted, the chip 18 may interact with the POS system 40 similar to the way an inserted read only memory device might interact with a personal computer. The magnetic strip reader on the POS system 40 simply reads whatever information is provided by the magnetic strip emulator 20. Such information is no more than a typical static magnetic strip would provide, but the magnetic strip emulator 20 allows for the provision of the dynamic transaction number as it changes with each time interval.

The processor network 38 contacts the issuer server 26 with the transaction request. Once communication is established between the processor network 38 and the issuer server 26, the processor network 38 provides the identification information. The issuer server 26 uses the identification information to determine if the issuer has an existing account with the same identification information encoded. If the issuer does not, the issuer declines the transaction. If the issuer does have account with the identification information encoded, then the transaction request proceeds to a validation procedure.

In the next step of the validation, the processor network 38 provides the issuer server 26 with the transaction number. Using the time received by the radio receiver 32 and sent in the radio signal, the issuer server 26 runs the transaction number function to generate an output of the first step of the transaction number algorithm. On the server 26, the issuer outputs the result of the transaction number function to the next step in the transaction number algorithm, namely, digit stripping. The ruleset stored on the server memory 30 is executed by the processor 28 on the server 26, and the server 26 strips the digits from the output of the transaction number function using whichever embodiment the issuer and the cardholder have agreed upon. The issuer server 26 checks the result against the provided transaction number. If there is a match, the issuer validates the transaction. If there is not a match, the issuer declines the transaction.

In performing the validation, the issuer takes the received time information from the radio signal, and inputs that information in to the transaction number function. Because there is a single source for the radio signal, for example the broadcast from Fort Collins, Colo., the time used by the payment card 12 and the time used by the issuer server 26 are very closely synchronized. The predetermined time interval length is critical in facilitating the transaction requests. If the predetermined time interval is too short, the time it takes to the transaction request to go through may cause the system to move beyond the time interval, yielding a declined transaction request. Such a “false positive,” that is, it is a legitimate transaction request from the cardholder, but is declined because the transaction number determined by the payment card 12 and the transaction number determined by the issuer server 26 were determined in two different time intervals. While such results are nearly impossible to avoid on occasion, choosing a long enough time interval should avoid most occurrences. However, such false positives should not be the result of the use of different time signals because there is only a single broadcast.

If the transaction is approved, the issuer determines the funds to be transferred and provides the transfer to the processor network. The processor network routes the funds to the acquirer identified in the transfer, where the funds are deposited on behalf of the merchant.

Below are a number of nonlimiting example embodiments of the description above.

In a 1st Example, a system for greater security of a payment card number, comprising: a virtual card application configured to run on a smart device, the smart device including a first processor electrically connected to a first memory, the first memory having stored on it the payment card application, the first processor executing the virtual card application, the virtual card application including a transaction number algorithm; the transaction number algorithm including: a transaction number function which uses time as a variable to generate a first transaction number function output; and a ruleset which uses the first transaction number function output as an input and strips at least one randomly determined digit from the first transaction number function output to determine a first transaction number; and an issuer server electronically connected to the smart device, the issuer server receiving the first transaction number from the payment card, the issuer server including: a second processor electrically connected to a second memory, the second memory including a copy of the transaction number algorithm, the second processor executing the copy of the transaction number algorithm, the copy of the transaction number algorithm including:

a copy of the transaction number function using time as an input and outputting a second transaction number function output; and a copy of the ruleset which inputs the second transaction number function output and strips predetermined digits from the second transaction number function output to determine a second transaction number to check against the first transaction number from the payment card.

In a 2nd Example, the method of Example 1, wherein the first transaction number is determined for each of a plurality of time intervals each day.

In a 3rd Example, the method of any of Examples 1-2, wherein the transaction number function is a highly oscillating function.

In a 4th Example, the method of Example 3, wherein the transaction number function output is determined at discrete time intervals.

In a 5th Example, the method of any of Examples 2-4, wherein the at least one randomly determined digit is unchanging for each of the plurality of time intervals after being determined

In a 6th Example, the method of any of Examples 2-5, wherein the at least one randomly determined digit is independently determined for each of the plurality of time intervals.

In a 7th Example, the method of any of Examples 1-6, wherein the transaction number function is a table stored on the first memory.

In a 8th Example, a method for creating a transaction number for use in a card transaction, comprising: determining a current time; inputting the current time to a payment card application running on a smart device, the payment card application including a transaction number function;

determining a plurality of digits using the transaction number function; outputting the plurality of digits from the transaction number function; inputting the plurality of digits to a ruleset, the ruleset stripping at least one randomly determined digit from the plurality of digits to generate a transaction number; configuring the transaction number for transmission on a payment card system for use in a payment card transaction request.

In a 9th Example, the method of Example 8, wherein the current time is received in a wireless signal.

In a 10th Example, the method of any of Examples 8-9, wherein the transaction number function is a highly oscillating function.

In a 11th Example, the method of any of Examples 8-10, wherein the ruleset strips a static set of digits from the plurality of digits.

In a 12th Example, the method of any of Examples 10-11, wherein the transaction number function is determined at discrete time intervals.

In a 13th Example, a system for greater security of a payment card number, comprising: a virtual card application configured to run on a smart device, the virtual card application including: a transaction number function which uses time as a variable to generate a first transaction number function output, the transaction number function executing on a first processor electrically connected to a first memory of the smart device, the first memory storing the transaction number function; a set of control surfaces generated by the virtual card application, the control surfaces appearing on a display of the smart device, the set of control surfaces allowing a cardholder to edit the first transaction number function output by removing at least two predetermined digit locations, at least two of which are non-consecutive, in order to determine a first transaction number; an issuer server electronically connected to the smart device running the virtual card application, the issuer server receiving the first transaction number from the smart device, the issuer server including: a second processor electrically connected to a second memory, the second memory including a copy of the transaction number algorithm, the copy of the transaction number algorithm including: a copy of the transaction number function using time as an input and outputting a second transaction number function output; and a copy of the ruleset which inputs the second transaction number function output and strips predetermined digits from the second transaction number function output to determine a second transaction number to check against the first transaction number from the payment card.

In a 14th Example, the system of Example 13, further comprising at least one wireless transceiver, the at least one wireless transceiver receiving a signal including information providing the current time.

In a 15th Example, the system of any of Examples 13-14, further comprising a crystal oscillator circuit electrically connected to the processor, the crystal oscillator circuit providing time signals to the processor.

In a 16th Example, the system of any of Examples 13-15, wherein the ruleset strips a static set of digits in each time interval.

In a 17th Example, the system of any of Examples 13-16, wherein the transaction number function is a table stored in the first memory.

In a 18th Example, the system of Example 17, wherein the table includes a set of digits for each time interval.

In a 19th Example, the system of any of Examples 13-18, further comprising a display electrically connected to the first processor, the display displaying the output from the transaction number function.

In a 20th Example, the system of any of Examples 13-19, wherein the transaction number function is highly oscillating function.

The above description is given by way of example, and not limitation. Given the above disclosure, one skilled in the art could devise variations that are within the scope and spirit of the invention disclosed herein, including various ways of forming the transaction number function. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system for greater security of a payment card number, comprising:
a virtual card application configured to run on a smart device, the smart device including a first processor electrically connected to a first memory, the first memory having stored on it the payment card application, the first processor executing the virtual card application, the virtual card application including a transaction number algorithm;
the transaction number algorithm including:
a transaction number function which uses time as a variable to generate a first transaction number function output; and
a ruleset which uses the first transaction number function output as an input and strips at least one randomly determined digit from the first transaction number function output to determine a first transaction number; and
an issuer server electronically connected to the smart device, the issuer server receiving the first transaction number from the payment card, the issuer server including:
a second processor electrically connected to a second memory, the second memory including a copy of the transaction number algorithm, the second processor executing the copy of the transaction number algorithm, the copy of the transaction number algorithm including:
a copy of the transaction number function using time as an input and outputting a second transaction number function output; and
a copy of the ruleset which inputs the second transaction number function output and strips predetermined digits from the second transaction number function output to determine a second transaction number to check against the first transaction number from the payment card.

2. The method of claim 1, wherein the first transaction number is determined for each of a plurality of time intervals each day.

3. The method of claim 1, wherein the transaction number function is a highly oscillating function.

4. The method of claim 3, wherein the transaction number function output is determined at discrete time intervals.

5. The method of claim 2, wherein the at least one randomly determined digit is unchanging for each of the plurality of time intervals after being determined

6. The method of claim 2, wherein the at least one randomly determined digit is independently determined for each of the plurality of time intervals.

7. The method of claim 1, wherein the transaction number function is a table stored on the first memory.

8. A method for creating a transaction number for use in a card transaction, comprising:
determining a current time;
inputting the current time to a payment card application running on a smart device, the payment card application including a transaction number function;
determining a plurality of digits using the transaction number function;
outputting the plurality of digits from the transaction number function;
inputting the plurality of digits to a ruleset, the ruleset stripping at least one randomly determined digit from the plurality of digits to generate a transaction number;
configuring the transaction number for transmission on a payment card system for use in a payment card transaction request.

9. The method of claim 8, wherein the current time is received in a wireless signal.

10. The method of claim 8, wherein the transaction number function is a highly oscillating function.

11. The method of claim 8, wherein the ruleset strips a static set of digits from the plurality of digits.

12. The method of claim 10, wherein the transaction number function is determined at discrete time intervals.

13. A system for greater security of a payment card number, comprising:
a virtual card application configured to run on a smart device, the virtual card application including:
a transaction number function which uses time as a variable to generate a first transaction number function output, the transaction number function executing on a first processor electrically connected to a first memory of the smart device, the first memory storing the transaction number function;
a set of control surfaces generated by the virtual card application, the control surfaces appearing on a display of the smart device, the set of control surfaces allowing a cardholder to edit the first transaction number function output by removing at least two predetermined digit locations, at least two of which are non-consecutive, in order to determine a first transaction number;
an issuer server electronically connected to the smart device running the virtual card application, the issuer server receiving the first transaction number from the smart device, the issuer server including:
a second processor electrically connected to a second memory, the second memory including a copy of the transaction number algorithm, the copy of the transaction number algorithm including:
a copy of the transaction number function using time as an input and outputting a second transaction number function output; and
a copy of the ruleset which inputs the second transaction number function output and strips predetermined digits from the second transaction number function output to determine a second transaction number to check against the first transaction number from the payment card.

14. The system of claim 13, further comprising at least one wireless transceiver, the at least one wireless transceiver receiving a signal including information providing the current time.

15. The system of claim 13, further comprising a crystal oscillator circuit electrically connected to the processor, the crystal oscillator circuit providing time signals to the processor.

16. The system of claim 13, wherein the ruleset strips a static set of digits in each time interval.

17. The system of claim 13, wherein the transaction number function is a table stored in the first memory.

18. The system of claim 17, wherein the table includes a set of digits for each time interval.

19. The system of claim 13, further comprising a display electrically connected to the first processor, the display displaying the output from the transaction number function.

20. The system of claim 13, wherein the transaction number function is highly oscillating function.
